(19) United States
(12) Patent Application Publication
(10) Pub. No.: US 2007/0219988 A1
(43) Pub. Date: Sep. 20, 2007

(54) Enhanced Patent Prior Art Search Engine

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,447

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06F 17/30

(52) U.S. Cl. 707/5

(57) ABSTRACT

A search engine configured to search a database of documents and provide search results to an end user is described. The search engine may be configured to provide the end user with a list of synonyms for terms in the search query submitted by the end user and allow the end user to identify those synonyms which should be included in the search engine. Alternatively or additionally, the search engine may be configured to provide the end user with survey questions, the answers to which, may be used to further define the search query. The database may include notes and/or advertisements that are associated with specific documents in the database.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

According to various embodiments, the present disclosure provides search engine that stores or otherwise has access to patent applications and other forms of prior art, including documents, articles, blogs, white papers, web sites, survey question responses and/or notes, among other prior art and other electronic materials. Furthermore, the search engine has the ability to query, search, and/or index the electronic materials.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application, includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes. Exemplary methods to provide attachment of notes into documents and/or associate notes with documents, or words, or other data are disclosed in U.S. patent application Ser. No. 11/690,095 “Facilitating Certified Prior Art Note Taking and Method for Using Same,” filed Mar. 22, 2007; (Attorney docket No. 3307102) entitled “Note Overlay System,” filed Apr. 6, 2007; Ser. No. ______ and (Attorney docket No. 3307103) entitled “Document Examiner Comment System,” filed Apr. 6, 2007; each of which is incorporated herein by reference.

Patent Application—includes an invention disclosure that has been filed with a registration entity such as the USPTO

Patent Application Drafting Tool—includes a web based software program that assists in the drafting and filing of patent applications with a registration entity such as the USPTO. An exemplary patent application drafting tool is described in U.S. patent application Ser. No. 11/627,263, which is hereby incorporated by reference.

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

In an embodiment, a new search engine may be provided, and/or any existing search engine may be improved to include the disclosed methods. For example, any search engine such as those provided by Google or Yahoo might be modified to incorporate one or more of the disclosed features, methods or inventions. Improving an existing search engine provides many benefits, including, the ability to retain and make use of all the existing features and functions of any such existing search engine. Adding one or more of the disclosed embodiments may also serve to provide any such search engine with additional features and benefits that can help to differentiate such existing or new search engine over any one or more of its competitors that are either unwilling or unable to incorporate the disclosed invention. Another advantage of making use of an existing search engine is that the end user would have access to the existing infrastructure and database access already in existence within such search engine's reach. Many of these search engines, e.g., Google, already have extensive feature sets and data access. Moreover, these tools already have searched or otherwise cataloged millions of web pages and other information sources. Conversely, creating a new search engine may prove generally more desirable in certain applications where the existing search engine relies on outdated and/or is otherwise generally of poor quality or lacks basic functionality and/or is difficult to use. In such cases, a new search engine may be patterned off an existing engine and/or may be constructed with minimal or without such influences.

In certain embodiments, end users or new or existing search engine or other websites and/or applications may permit and/or enable the entry or attachment of, or otherwise permit, one or more end users to import and/or provide patent applications or other documents, including text and/or graphics and/or hyperlinks or notes associated with any of the above and/or any other relevant data, files, images, documents, survey question responses, notes and/or hyperlinks to any one or more of the above and/or any combination of the above. In other embodiments, patent and other information, including, for example, survey responses, notes, documents, images, advertisements, white papers, or other items or any relevancy or mapping information and/or other documents and/or hyperlinks is/are accessed from existing or newly created databases and/or one or more indices and/or a new or modified search engine or other tool and/or a combination of the above.

In certain embodiments, the disclosed system periodically searches for and/or stores information and/or references in the prior art to each word and/or group of words, phrases, and/or documents, notes and/or synonyms and/or antonyms in the patent application or document, IDS, and/or the examiner's, applicant's or third party's notes, or other database information and creates one or more hyperlinks and/or indices and/or database entries to or that reference such information and/or words and/or documents and/or references and/or synonyms and/or antonyms directly from the words of the patent application or other document(s), notes, survey responses or database information and/or its synonyms and/or antonyms or otherwise. Exemplary methods to provide for survey questions and gathering of data are disclosed by applicants in U.S. Patent Application No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

Methods to create or modify search engines are well known and understood within the prior art and by any person of ordinary skill. For example, methods to design and build a search engine are disclosed and discussed by the authors of the following books, including, for example “Understanding Search Engines: Mathematical Modeling and Text Retrieval (Software, Environments, Tools), Second Edition, by Michael W. Berry and Murray Browne, which is incorporated by reference. Methods to create web pages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide

Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of the above is hereby incorporated by reference.

In another embodiment, by creating hyperlinks and/or otherwise indexing such words and group of words, and/or synonyms and/or antonyms, etc., a cross referenced index and/or set of hyperlinks and/or indices is/are made available for subsequent analysis, searching and use. For example, using an application or user interfaced designed for such purposes, end users can click on or otherwise activate any one or more hyperlink(s) and/or index or table of contents or other entries to view one or more lists of any of the prior art and/or other documents that include one or more of such words or group of words and/or their synonyms and/or antonyms and/or reference any such words, group of words, synonyms and/or antonyms. Such hyperlinks and/or index entries may be ordered by any applicable means, for example, such lists may be ordered or sorted based on any one or more of the: number of times the words are found in the reference material, e.g., patent or document, number of times such related references have been accessed, and/or feedback provided by one or more end users, one or more relevancy scores and/or mapping information and/or one or more notes provided by end users and/or as may be generated by any applicable computing means, such as lexical or grammatical analysis or any other applicable means including genetic algorithms, relative age of one or more such references, e.g., references to a word in a more recently created document, may be sorted in preference older document entries, extent of usage, depth or breath of the map, e.g., if a word is used more frequently in a greater number of documents, especially those documents that may also have been deemed relevant, such word or its related index entry or hyperlink may be sorted above other index entries or hyperlinks that have fewer cross references and/or fewer documents, and/or based upon prior usage information. Maps and relevancy scores may be determined by any applicable means, including those described herein and in the disclosures which have been incorporated herein by reference.

Exemplary systems and methods related to keyword-based advertising in a document database are described in U.S. patent application Ser. No. 11/668,586 “Targeted Advertising Based on Invention Disclosures,” filed Jan. 30, 2007; Ser. No. 11/668,596, “Keyword Advertising in Invention Disclosure Documents,” filed Jan. 30, 2007; Ser. No. ______ (Attorney docket No. 3303103) “Merchant Tool for Embedding Advertisement Hyperlinks to Words in a Database of Documents” filed Apr. 6, 2007; and Ser. No. ______ (Attorney docket No. 3303104) “Self Teaching Thesaurus,” filed Apr. 6, 2007; each of which is hereby incorporated by reference.

Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each of which are incorporated by reference.

In other embodiments, relevancy scores may be determined, in whole or in part, through the use of manual and/or automated means. In addition to the novel relevancy ranking methods disclosed herein, other methods to determine relevancy between and among documents and/or websites are well known within the prior art, including, for example, the methods discussed in the book entitled “Text Databases and Document Management: Theory and Practice, by Amita Goyal Chin, which is incorporated by reference.

In another embodiment, prior usage of the system may be tracked via any applicable means, including, for example, as end users submit and/or click on hyperlinks and/or index entries and/or use any one or more features of the system, the system could record such usage activity and rank future search results and/or modify system performance based upon such usage information. The system could, for example, determine how many times a given hyperlink or index entry is clicked and then, optionally, determine the relevancy of the hyperlinked or indexed document, for example, such relevancy may be based upon any applicable means including the frequency with one or more end users click such hyperlink or index and/or the amount of time one or more end users spend reviewing such hyperlinked or indexed document, and/or using feedback provided by any one or more end users, such as feedback provided via a score, relevancy ranking, weighting ranking, notes, or by clicking on or answering questions that provides or permits the calculation of such relevancy scores based upon such responses. Exemplary methods to provide for such feedback using notes and or survey response questions are disclosed in U.S. Patent Application No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

In another embodiment, end users can scroll through or otherwise review a document using any applicable means, for example, by title or abstract, relevancy, and/or line by line, paragraph by paragraph, and/or page by page and the system displays the most relevant documents associated with line, paragraph or page. Such display or list of relevant documents may appear in a separate web browser pages or tabs, and/or in a popup or other user interface, e.g., a list displayed directly on the display alongside the application's text or graphics.

In addition or in the alternate, one or more of the words and/or groups of words, e.g. phrases or search strings, and/or other words in the patent application are placed into one or more search boxes in the GUI, where they can be clicked or otherwise selected by the end user to view potentially related prior art. As words or groups of words are placed into one or more search engine windows, e.g. an improved Google search window, such search engines could immediately conduct searches on such word or words and display a partial or comprehensive search result in the search window or another window. In this fashion, end users are constantly being presented with search results. End users may periodically review such results to determine if any one or more result is meaningful or could prove use or otherwise deserves further review or investigation.

According to another embodiment, the end user can select or otherwise indicate how he wants to view the relevant prior art. Such selection or indication may be provided through any applicable means, and includes, but is not limited to the use of and/or ranking by the:
1. number of similar words used
2. earliest filing date
3. latest filing date
4. inventor
5. percentage match to the word or words
6. synonyms
7. antonyms
8. relevancy or popularity scores
9. ranking or sorting criteria provided by the end user that controls whether or not one or more variables are used, and/or how the results are sorted, listed and/or filtered.
10. combination of any two or more of the above

In another embodiment, in addition to finding prior art based on the words of the patent application, the system also lists synonyms and/or antonyms of the word or groups of words or phrases. For example, the end user can click on one or more relevant synonyms and the system can do a prior art search based on those relevant synonyms. The synonym list can be generated from words that merchants who purchase keywords from a search engine select as common words when creating a web-based advertisement. Methods for creating such a list of synonyms are disclosed in U.S. patent application Ser. No. ______ (Attorney docket No. 3303104) entitled “Self-Teaching Thesaurus,” filed Apr. 6, 2007 which is incorporated by reference.

In another embodiment, each section of a patent application can be searched in the manner described above and search results can be weighted and/or sorted and/or filtered based on which section of the cited prior art contains the word, group of words or synonyms and/or antonyms and/or any one or more of the end user's search, sort, select and/or display preferences. For example, if an end user is interested in or is reviewing abstracts of patents, the potential applicability or relevancy of a given word or phrase may be greater if such word or phrase appears within the abstract section of one or more other patents, as opposed to appearing in the claims section of one or more other patents. In addition or in the alternate, relevancy of one or more words may be determined by the appearance of the word or words in any or all of the sections of a patent or patent application, whether or not such patent is pending or has previously issued

In another embodiment, the synonyms and antonyms list can be established or affected by end user actions, preferences and/or feedback. For example, the system can provide a list of words that it expects or determines are synonyms based on the text of the patent application. The end user can indicate which words on the list are synonyms. The system can use the indication by the end user to further refine its synonym list for later searches. By combining the end user feedback, preferences and/or by tracking behaviors of two or more, or large sets or classes of end users, the system can improve the usefulness of the system by improving its ability to determine which words or group of words or phrases are generally more relevant and separate those from other words, groups of words or phrases that might typically be considered relevant, i.e., if searching a generic or generally available thesaurus vs. use of a customized thesaurus as disclosed herein and/or via use of end user feedback or usage tracking. Therefore, the disclosed invention provides both initial and ongoing performance results over existing search methods.

In another embodiment, when searching prior art, certain or all sections of patents may have different weights associated with such search results. For example, patent prior art reference may be cited as more relevant if a section of it uses the same or similar language as a patent application submitted or being drafted by an end user. For instance, if the claim of a prior art patent uses the same or similar words as a patent application, it may be considered as generally more relevant than a prior art patent that uses the same words in the background of the application or patent.

In yet another embodiment, when searching for relevant patent documents, there can be several measures of relevancy. For example, the system may determine relevancy using any applicable means, including any one or any combination of:
1. The frequency of a search term: Where a key word appears more often in patent document A than in patent document B, then patent document A is determined to be generally more relevant (according to this measure).
2. The frequency of the appearance of a synonym of the search term. Where a synonym of a key word appears more often in patent document A than in patent document B, patent document A is determined to be generally more relevant (according to this measure).
3. The frequency of the appearance of an antonym of the search term. Where an antonym of a key word appears more often in patent document B than in patent document A, then patent document A is determined to be generally more relevant (according to this measure).
4. User feedback. Where a search produces results, end users may have the option to indicate to the system which of the results, in whole or in part, are actually relevant by, e.g., requesting to see the abstract, requesting to view the whole document, requesting to download part or all of the document(s), requesting to save such part or whole of the whole document(s) in a ‘folder’ on the system of saved results. Feedback from end users may affect their individual future search results and/or search algorithms and/or may affect all or a class of end user's future results. Such affects on groups or classes of end users may carry significant weighting, and/or may only affect such future searches in smaller incremental ways. A combination of these may also apply. For example, if end user A determines certain patents or other prior art documents are relevant to his particular patent search, such knowledge may be useful in determining relevancy for future prior art searches conducted by end user A, and/or such information may affect end user B's future prior art searches, particularly if end user B has or does conduct searches within the same filed of use and/or uses the same or similar lists of synonyms, antonyms and/or other words, groups of words or phrases, and/or tends to determine that the same or similar lists of patents or prior art and/or search strings and/or responses to survey questions regarding any of the forgoing are the same or are similar to end user A.
5. A ‘relevancy function’ that aggregates all or groups of the measures provided by end user or other feedback using any applicable means. For example, this relevancy function can be based upon, in whole or in part, and/or modified using various feedback techniques (e.g. neural networks, expert or rules based systems and/or genetic algorithms). Use and applications of rules based, expert systems and/or genetic algorithms are well known in the prior art and may be implemented using any applicable means. For example, methods to develop rules, expert systems and/or genetic algorithms are discussed and disclosed in various issued and pending patents and reference and other materials, including the following books entitled: “Genetic Algorithms in Search, Optimization, and Machine Learning”, by David E. Goldberg, and “An Introduction to Genetic Algorithms,” by Melanie Mitchell, and “Expert Systems: Design and Development,” by John Durkin,” and “Logical Foundations for Rule-Based Systems (Studies in Computational Intelligence),” by Antoni Ligeza, each of which are incorporated herein by reference.
6. Based on a thesaurus of words created from merchants who purchase keywords to display advertisements.
7. Based upon end user responses to one or more survey questions.

In another embodiment, searches can be rated by inventors, attorneys, examiners and/or any other authorized person, entity, or system. The search rating can be tied, in whole or in part, or have an influence on, a rating of the searcher or end user, and/or may be associated with particular prior art or other documents.

In yet another embodiment, attributes, characteristics, qualifications and/or other criteria relating to one or more end users that search, may have a relevance weight for subsequent searches that is greater or less than other end users. For example the relative weight of a patent examiner's opinion or feedback may have a greater influence when determining relevancy scores or rating than the weight of an opinion or feedback of an independent inventor. Using such a discriminatory practice in assigning or otherwise determining relevancy scores, may provide more relevant feedback and/or a more useful, efficient or effective system. In one embodiment, such weighting tends to consider feedback from qualified professionals more heavily than that of laypersons. For example, patent examiners and/or other qualified personnel the USPTO may carry more weight than a given patent attorney, which may, in turn, carry more weight than that of a given inventor. In yet another embodiment, in addition or in the alternate, such weighting criteria may also be based in whole or in part upon other factors or learned information regarding an end user's past performance or feedback. For example, if a given end user A has provided scores and/or rankings, e.g., one or more relevancy scores, and other end users confirm such score or ranking as accurate or generally useful, then such end user A's future feedback or rankings or scores may carry more weight than another given end user, e.g., end user B, who may not have yet provided any feedback or scores, or if end user B has provided such feedback but such feedback has yet to be verified by the system or via other end user verification methods, then such end user B's current or future feedback or rankings may not carry as much weight as end user A's. In yet another embodiment, these concepts can be combined, for example, in the preceding case, end user A's feedback was determined to carry more weight, however, if additional information were available regarding end user B, for example, if end user B is a patent examiner, then end user B's feedback or rankings may carry the same or even greater weight than end user A, based upon such additional information as it may be assumed that a patent examiner's feedback is more valuable than another end user that is a lay person.

In another embodiment, the database of the computer or system or server that is conducting the search may affect the search results and/or their sort order. This search engine generates results based on information contained in the searcher's computer other than search history. For example, an end user may choose to provide and/or the system may track additional information regarding the end user and/or his search preferences. Such information and preferences may include any applicable criteria or information such as: the end user's typical or primary field of use, custom list of synonyms or antonyms, custom relevancy scores and ranking results or criteria, previous acceptance or rejection of one or more search results or prior art data, e.g., if an end user determines a particular piece of prior art or other information or data is not relevant, such end user may flag such prior art or data so that it may not appear on subsequent future searches which may or may not be similar to such historical searches, and/or the system may be designed such that each end user or class of end user has a dedicated search algorithm, for example, instead of using a genetic algorithm for all end users, one or more genetic algorithms may be used, stored, modified, etc., for each end user and/or for each class or category of end users. For example, there may be one set of GA's for patent examiners, while there might be another set of GA's for patent attorneys that provide patent services for devices, and yet another set of GA's for patent attorneys that provide patent services for business method patents. Any suitable means may be used to determine the number of end user classifications for such purposes, including, for example, use of another superset of GA's that determines applicable categorizations of end user types. In this fashion, the system is continually learning and determining into which categories each end user or groups of end users should fall, thereby improving system performance results across one or all of such groups.

In certain embodiments, the disclosed invention may be practiced in the real or virtual world. For example, a video game or virtual environment may provide for a virtual patent office or other system that permits the registration of intellectual property. Such system may also permit the inclusion of the disclosed invention. For example, a video game may include a virtual patent office. Exemplary methods and systems for providing protection of intellectual property in a virtual environment are disclosed, for example, in U.S. patent application Ser. No. 11/428,263, “Video Game Environment” filed Jun. 30, 2006; Ser. No. 11/620,563 “Copyright of Digital Works in a Virtual Environment,” filed Jan. 5, 2007; Ser. No. 11/689,977, “Digital Rights Management in a Virtual Environment,” filed Mar. 22, 2007; Ser. No. 11/671,373 “Video Game with Control of Quantities of Raw Materials” filed Feb. 5, 2007; Ser. No. 11/680,960 “System for the Creation and Registration of Ideas and Concepts in a Virtual Environment,” filed Mar. 1, 2007; each of which is incorporated herein by reference.

Furthermore, such a system may permit improvements to itself. For example, a video game may permit the inclusion by end users of modules or plug-ins, which provide additional features or other improvements relating to the virtual environment, video game or improves game play. Exemplary methods and systems for providing such plug-in support are disclosed in U.S. patent application Ser. No. ______ (Attorney docket No. 3306105) entitled “Method and System to Provide Certified Third Party Plug-ins into a Patent Drafting System,” filed Apr. 6, 2007 which is hereby incorporated by reference.

Accordingly, the disclosed invention may be applied to such virtual environment, world or video game(s) or any combination of the forgoing. For example, use of modules or plug-ins, such as those disclosed herein may be delivered and/or used within the virtual world. In the event an agreement between two or more parties may be desired or required to insert any module or plug-in and/or to make use of any such plug-in, methods to ensure that agreements are enforceable and that advertising fees are collected in such virtual environments are desirable. Exemplary methods for providing such contract enforcement and collection of fees are disclosed, for example, in U.S. patent application Ser. No. 11/279,991 “Securing Virtual Contracts with Credit,” filed Apr. 17, 2006; Ser. No. 11/624,662 “Securing Contracts in a Virtual World,” filed Jan. 18, 2007; Ser. No. 11/559,158 “Financing Options in a Virtual World” filed Nov. 13, 2006; Ser. No. 11/620,542 “Satisfaction of Financial Obligations in a Virtual Environment Via Virtual and Real World Currency,” filed Jan. 5, 2007; Ser. No. 11/421,025 “Financial Institutions and Instruments in a Virtual Environment,” filed May 30, 2006, and Ser. No. 11/380,489 “Multiple Purchase Options for Virtual Purchases,” filed Apr. 27, 2006; each of which are hereby incorporated herein by reference.

In yet another embodiment, hyperlinks and or indices may include one or more advertisements and/or hyperlinks to one or more advertisements and/or survey questions. Delivery and timing of such advertisements and/or survey questions may be accomplished via any applicable means. For example, in order to determine or gather information about the relevancy of certain prior art to a given patent application, the system may submit survey questions to one or more end users to gather such relevancy data. In another example, merchants or other advertisers may desire to attach one or more advertisements and/or surveys to one or more keywords, hyperlinks, and/or prior art documents, or words, phrases, and other data.

It should be understood that any embodiments herein which refer to a patent are equally applicable to a patent application, and vice versa, unless explicitly stated otherwise with respect to a particular embodiment. Any references to a patent (or to a patent application) are for reasons of brevity only.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:
1. Search Program
2. Search Weight Program
3. Search Relevancy Program
4. Hyperlink Program
5. Documents Submission Program
6. Documents Relevancy Program
7. Mapping Program
8. Dispute Program

Exemplary database architectures include:

Word Database
1. Word ID
   a. Word Count ID
   b. Word
   c. Primary Definition
   d. Hyperlinks 1-N (e.g., sources/locations of use)
   e. Alternative Definitions 1-N
      1. Definition
      2. Supplied By—ID
      3. Hyperlinks 1-N
   f. Synonym ID—1-N
      1. Synonym
      2. Word ID
      3. Relevancy Scores 1-N
      4. Primary Score %
      5. Alternative Score %'s 1-N
   g. Antonym ID—1-N
      1. Antonym
      2. Word ID
      3. Relevancy Scores 1-N
      4. Primary Score %
      5. Alternative Score %'s 1-N
   h. Notes 1-N
      1. Note ID
      2. Note Short Description
      3. Note Long Description
      4. Narrative Text
      5. Attachment Hyperlinks 1-N
      6. Where Used Hyperlinks 1-N
   i. Figure IDs 1-N
   j. Change Tracking ID 1-N

Change Tracking Database
1. Change Tracking ID
2. Word ID
3. Change Type (e.g., Add, change, delete)
4. Change Description
5. Date/Time
6. User ID
7. Before Image
8. After Image
9. Relevancy or Score
10. Notes 1-N

Figure Database
1. Figure ID
2. Figure Description
3. Figure or Attachment
4. Submitted By ID
5. Source ID
6. Editor Application ID
7. Document/Patent Application Where Used ID 1-N
   a. Hyperlinks 1-N
8. Notes 1-N
   Document Database
1. Document ID
   a. Document Description
   b. Document Owner ID
   c. Hyperlinks (e.g., document locations) 1-N
   d. Class 1-N
   e. Subclass 1-N
   f. Type 1-N
   g. Subtype 1-N
   h. Date/Time Stamps
      1. Submitted/Found/Indexed On
      2. Submitted/Found/Indexed By ID or Hyperlink
      3. Revised On 1-N
      4. Revised By 1-N
      5. Before Image 1-N
      6. After Image 1-N
2. Notes 1-N

Hyperlink Database
1. Hyperlink ID
2. Hyperlink
3. Description
4. Owner ID
5. Advertiser ID
6. Notes 1-N

Lexicon Database
1. Lexicon Database ID/Name/Location
2. Lexicon (e.g., Word or Document or Image) ID # 1-N
3. Submitted by ID # 1-N
4. Examiner ID # 1-N
5. Attorney ID # 1-N
6. Description
7. Notes 1-N
8. Lexicon Image 1-N
9. Date/Time Submitted
10. Notes 1-N

Usage Database
1. Usage Transaction ID
2. Application Id
3. Application Type
4. Date/Time
5. Duration of Usage
6. User ID
7. Transaction Type
8. Search Strings/Words Entered 1-N
9. Relevancy Feedback Rankings 1-N
10. Documents Accessed 1-N
11. Duration of Access 1-N
12. Words Used/Modified/Submitted 1-N
13. Definitions Used/Modified/Submitted 1-N
14. Mapping Feedback Information 1-N
15. Plug-ins Used 1-N
16. Hyperlinks reviewed/clicked 1-N
17. Advertisements reviewed 1-N
18. Billing Information

User Score Database
1. Score ID
2. Date/Time
3. User ID
4. Score/Feedback Rules ID 1-N
5. Score/Feedback Category
6. Score/Feedback Type
7. Score/Feedback Item
8. Score/Feedback Rankings 1-N
   a. Relevancy Ratings
   b. Usefulness Ratings
   c. Mapping Feedback
   d. Mapping Ratings

Score Rules Database
1. Rule ID
2. Rule Description
3. Rules 1-N

Search Box Database

User Search Preferences Database
1. User ID
2. Search Preferences 1-N
3. Sort Preferences 1-N
4. Display Preferences 1-N
5. Primary Field of Use
6. Additional Field's of Use 1-N
7. Display Synonyms Y/N #
8. Display Antonyms Y/N #
9. Display Titles or Summaries of Relevant Documents
10. Display Definitions Y/N #
   Document Section Database

Relevancy Database
1. Relevancy ID
2. Relevancy Type
3. Document/Word/Map ID
4. Relevancy Score Summary
5. Detail Relevancy Transaction Data
   a. Transaction ID 1-N
      1. Relevancy Type
      2. Document/Word/Map ID
      3. Relevancy Score Summary

User Database
1. User ID
2. User Type
3. Name
4. Account Type
5. Description
6. Terms and Conditions ID
7. Text
8. Notes 1-N

User Type Database
1. User Type ID
2. Type Description
3. Permissions
4. Restrictions
5. Notes 1-N

Searcher Computer Type Database

Searcher Computer Database

It will be appreciated that the various software and hardware components described above will be configured to perform a variety of functions and methods. Listed below are some exemplary methods that might be performed by the systems as described herein:

Import Text for Search
1. Receive Patent Data
2. Generate Search Document from Patent Data

Perform Search
1. Apply Search Algorithm to Search Document
2. Generate Appropriate Prior Art Documents from Search Document

Generate Search Results Page
1. Compile list of Prior Art Documents
2. Output List of Prior Art Documents

Track Usage
1. Receive an indication that a prior art document was reviewed in response to the document being listed in a prior art document list
2. Store indication of review including review details

Usage Creates Score
1. Retrieve Indication of Review Logs
2. Score Documents Based on Logs

Score Effects Search Results
1. Apply scores to documents in database
2. Weight document relevancy based on scores

Display Sections of Documents and Most Relevant Prior Art for That Section
1. Receive Sectional Patent Data
2. Apply Search Algorithm with Sectional Preferences to Document Database
3. Generate list of prior art from document database
4. Sort prior art list using sectional preferences
5. Output list sorted by sectional preference

Place Words in Search Boxes
1. Receive words and/or word phrases
2. Generate prior art for word or word phrases
3. Place word or word phrases in search box if prior art list meets or exceeds criteria
4. Place prior art for words or word phrases in appropriate box

Review Word in Search Boxes
1. Receive a request to review a prior art reference in a search box
2. Output Prior Art Document

Filter Searches Using Preferences
1. Receive/Generate/and/or Determine search preferences
2. Apply Preferences to Searches
3. Output modified search result that has been filtered from end user preferences

Weight Search Results Based on Document Sections
1. Generate search results, including prior art references, for a data submission
2. Apply sectional preference criteria to search results
3. Filter and sort prior art references based on sectional preference criteria

Weight Search Results Based on Document Status
1. Generate search results, including prior art references, for a data submission
2. Apply Document Status criteria to search results
3. Filter and sort prior art references based on document status criteria

Synonym Search Enhancement Program
1. Receive Data Submission
2. Apply Synonyms to Data
3. Generate search document based on data submission and synonyms
4. Apply Search Engine Algorithm to search document
5. Generate and Output Search Results

Synonym Feedback Program
1. Receive Data Submission
2. Output List of Potential Synonyms
3. Receive indication that synonyms are relevant
4. Link relevant synonyms to appropriate sections of data submission

Produce Search Results Based on Relevancy Conditions
1. Receive Data Submission
2. Apply search engine algorithm to data submission
3. Generate Search Results
4. Retrieve Relevancy Conditions
5. Apply Relevancy conditions to search results
6. Filter and sort search results based on relevancy conditions
7. Output Search Results

Weight Relevancy Based on User Type
1. Receive a user type
2. Receive a Data Submission
3. Generate a relevancy score based on user type
4. Generate Search Results
5. Apply relevancy score to search results
6. Filter and sort search results based on relevancy conditions
7. Output Search Results

Create Relevancy Based on Searcher Computer Type
1. Receive a computer type
2. Receive a Data Submission
3. Generate a relevancy score based on computer type
4. Generate Search Results
5. Apply relevancy score to search results
6. Filter and sort search results based on relevancy conditions
7. Output Search Results

Determine Searcher Computer Type
1. Receive a computer log in
2. Analyze Computer to Determine Type
3. Generate Computer Type
4. Store Computer Type

Find references with same words as text entered
1. Receive a Data Submission
2. Generate prior art documents with completely or partially identical data to submission
3. Score prior art documents based on percentage of likeness to data submission
4. Output prior art documents sorted based on percentage of likeness to data submission

Find references with synonyms of text entered
1. Receive a Data Submission
2. Generate a synonym list based on the data submission and rules
3. Generate prior art documents with completely or partially identical data to submission and/or synonym list
4. Score prior art documents based on percentage of likeness to data submission
5. Output prior art documents sorted based on percentage of likeness to data submission

Insert references into search boxes labeled with words and word phrases of the application
1. Receive a Data Submission
2. Generate search boxes based on words and word phrases in the data submission
3. Apply search engine algorithm to words and word phrases
4. Generate prior art list for each word/word phrase
5. Insert links to prior art references into appropriate search boxes

Establish preferences for viewing prior art
1. Receive a request to create a preference profile for viewing prior art
2. Generate and output a preference profile form
3. Receive Form Data
4. Create Preference Profile
5. Store Preference Profile

Establish relevance of search result based on which section a word or word phrase is cited
1. Generate a list of prior art in response to a data submission
2. Determine sections of prior art that are most relevant to data submission
3. Score and Sort prior art based on section relevancy
4. Output Sorted Prior Art List

Receive relevance score of a prior art reference from an end user
1. Generate and output a list of prior art in response to a data submission
2. Receive a relevancy score for each piece of prior art cited
3. Store relevancy score with prior art reference

Refine synonym list based on end user input
1. Generate and output a synonym list in response to a data submission
2. Receive additions/modifications/relevancy ratings for each listed synonym
3. Store additions/modifications/relevancy ratings
4. Modify synonym list in response to additions/modifications/relevancy ratings

Initial Database Loading
1. Create/Load Database(s)
2. Import or receive or input Prior Art, Documents, Words, Definitions, Synonyms and Antonyms, notes, commentary and/or opinions from existing database sources (as appropriate/e.g., one time, and/or from time-to-time)
3. If/as necessary, sign up end users, merchants, examiners, patent attorneys, and third parties
4. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns/preferences
   i. Display preferences

Security Application
1. Load Database(s)
2. Determine if requested action and/or end user is permitted
3. If not, notify application and/or end user
4. If yes, permit requested step and/or loading of application or other authorized action(s)
5. Update Database(s)

Opt In/Sign Up Application
1. Load Databases
2. Receiving Indication of new user sign up
3. Record any and all or available information regarding one or more patent applicants, end users, examiners, attorneys and/or third parties
4. Update Databases

Periodic Text/Document Import Application
1. Load Databases
2. Receive indication or determine need for text/Document Importation
3. Determine text/documents to import into one or more databases
4. Import or receive or permit entry of text and/or documents
5. Update Databases

Search Tool Application
1. Load Databases
2. Present Search GUI
3. Receive Prior Art or Document or other Search String Request
4. If desired, needed or requested, retrieve synonyms and display in separate search string box
5. Receive indication that end user prefers or clicks on synonym or otherwise has activated one or more hyperlinks
6. Determine if additional information and/or a survey is needed or desired
7. If needed or desired, execute survey program
8. Determine if advertisement should be displayed
9. Display advertisement if desired, needed, requested
10. Based upon available information, e.g., search string, synonyms and/or survey results, Search any or all available and/or participating databases and/or data warehouses
11. Retrieve results including prior art, other documents, synonyms, antonyms, advertisements, notes, hyperlinks, cases, and other search results data based upon any one or more of the forgoing and/or other search criteria
12. Determine weights, sort, filter and other system and/or end user search criteria of end user requesting search
13. Determine relevancy of results text/data/documents, etc. based upon any one or more criteria including:
   a. User Type
   b. User Preferences, weighting criteria
   c. Computer Type
   d. Search Engine Type or Provider Preferences
   e. Relevancy Conditions/Information
   f. Document results section weighting
   g. Survey Questions and/or responses
   h. Past or present end user feedback
14. Determine if results data should be displayed in one or more separate page(s), popup or other window(s)
15. Display results, in whole or in part, based upon relevancy, weighting factors, document section information, and/or in sorted/filtered order and/or store results in certified or encrypted database for subsequent user or examiner or third party access, and/or other available relevancy, sorting, display options criteria
16. Display one or more of the following, in whole or in part, if indicated, requested, needed or otherwise desired including, but not limited to:
   a. Results data
   b. Prior art
   c. Relevancy information
   d. End user weighting, criteria, sort, filter and/or display and/or other preferences or system settings
   e. Mapping information
   f. Synonyms and/or antonyms
   g. Definitions
   h. Figures
   i. Text
   j. One or more Documents
   k. Hyperlinks
   l. Advertisements
   m. Notes
   n. Any or all other data as desired/requested/necessary
17. Update Databases

Feedback and Performance Improvement Application
1. Load Databases
2. Receive indication of end user or system activity
3. Determine if end user feedback is indicated, required, necessary offered or is otherwise submitted or provided
4. Determine feedback category, including any one or more of the following categories/items, including the relevancy, accuracy, usefulness, completeness, effectiveness or appeal of any one or more of the following system settings, and/or data including, but not limited to:
   a. Results data
   b. Prior art
   c. Relevancy information
   d. End user weighting, criteria, sort, filter and/or display or other preferences or system settings
   e. Mapping information
   f. Synonyms and/or antonyms
   g. Definitions
   h. Figures
   i. Text
   j. One or more Documents
   k. Hyperlinks
   l. Advertisements
   m. Notes
   n. Ease of application or feature use
   o. Any or all other data as desired/requested/necessary
5. Request feedback and/or changes to and/or opinions regarding or relating to one or more affected end users regarding one or more feedback categories as defined/determined above and receive feedback information including at least one or more of the following, including, but not limited to:
   a. Relevancy rankings
   b. Scores
   c. Weighting factors or weights
   d. Sorting preferences
   e. Filtering preferences
   f. Display preferences
   g. Subjective criteria
   h. Notes
6. Use on screen feedback option or survey to solicit feedback
7. Receive End User Feedback
8. Determine and update relevancy, weighting criteria and/or other scores
9. If feedback warrants, or so indicates, request additional feedback on the feedback
10. Modify applicable/affected criteria including, but not limited to any relevant settings such as those relating to any one or more or part or all of a/an/the:
   a. Genetic or other learning algorithms
   b. Relevancy or scoring algorithms
   c. System, end user and/or other settings, weights, preferences, sort, selection, display criteria.
   d. End user or system weighting, criteria, sort, filter and/or display and/or other preferences or system settings
   e. Mapping information
   f. Synonyms and/or antonyms
   g. Definitions
   h. Figures
   i. Text
   j. Documents
   k. Hyperlinks
   l. Advertisements
   m. Notes
   n. Any or all other data as desired/requested/necessary
11. Update Databases

Usage Tracking Program
1. Load Databases
2. Receive indication of end user or system activity
3. Store Activity
4. When/if requested generate usage tracking/activity reports
5. Display reports and/or export data as requested/desired/needed
6. Determine if activity affects or is related to and/or is otherwise correlated to/with and/or could improve any results data including or system performance, including for example:
   a. Relevancy and/or scoring calculation methods or algorithms
   b. Advertising results
   c. Click through results
   d. Conversion rates
   e. End user feedback
   f. End user skills
   g. Search methods or algorithms
   h. Hyperlink use or relevancy
   i. Sort and/or filter methods, calculations and/or options
7. Provide performance data to genetic algorithm
8. Modify methods and/or algorithms and/or end user or other options based upon performance data
9. Update Databases

Patent Drafting Tool/Application
1. Load Database(s)
2. Display GUI
3. Display one or more Search String Box(es)
4. Receive activity indication/request from end user
5. Determine if one or more subroutines or applications should be executed
6. Execute one or more of the following subroutines as applicable/necessary/desired
7. Update database(s)

Security
1. Load Database(s)
2. Determine if requested action and/or end user is permitted
3. If not, notify application and/or end user
4. If yes, permit requested step and/or loading of application or other authorized action(s)
5. Update Database(s)

Word Creation/Modification Application
1. Load Database(s)
2. Display Word Entry/Revision GUI, if required
3. Receive input from user to add/modify/delete word and/or associated synonym, antonym and/or primary/alternative definition(s)
4. If Applicable
   a. Place word in one or more authorization queues
   b. Receive authorization/certifications as applicable and/or required to accept such add/modify/delete word and/or associated synonym, antonym and/or primary/alternative definition(s)
5. If applicable, receive relevancy score(s) and/or mapping information
6. Update Database(s)

Word Use/Insertion
1. Load Database(s)
2. Receive one or more requests to search or display one or more words, synonyms, antonyms and/or figures and/or maps
3. Retrieve relevant words, synonyms, antonyms and/or figures or maps
4. Display search/lookup results and, if applicable, other relevant materials
5. Permit user to copy/paste or insert any one or more such words, synonyms, antonyms and/or figures into one or more patent applications or other document(s)
6. Permit end user to submit additions/changes or modifications to such words, synonyms, antonyms and/or figures as applicable
7. Update Database(s)

Advertisement Creation Application
1. Load Database(s)
2. Display advertising creation/modification GUI
3. Receive request to add/change/delete one or more advertisements
4. Receive advertisement hyperlink contents and associate with one or more words, synonyms, antonyms and/or figures and/or documents
5. Determine if such one or more words, synonyms, antonyms, figures and/or documents have pre-existing hyperlinks by current or third party end user or otherwise
6. If not, determine price to associate hyperlink as applicable
7. If one or more similar hyperlinks already exist, execute hyperlink bid pricing application
8. If approved and priced, insert or otherwise associate said hyperlink with said one or more words, synonyms, antonyms, figures and/or documents.
9. Update Database(s)

Hyperlink Pricing Program
1. Load Database(s)
2. Receive Pricing Request
3. Determine if more than one user wishes a hyperlink to the same or similar word(s), synonym(s), antonym(s), figure(s) and/or documents
4. Determine pricing and/or auction hyperlink, or, if applicable, position in list of two or more hyperlinks
5. Notify affected parties, e.g., via an alert
6. Receive indication from one or more users as to willingness to pay and price points
7. Continue process until pricing is determined
8. Receive authorizing for final pricing from affected parties, including end users
9. Update Database(s)

Advertisement Viewing/Use Application
1. Load Database(s)
2. Receive request to display or access advertisement, e.g., user clicks hyperlink or right clicks word
3. Determine if additional browser page or popup or other display method is to be used
4. Display Advertisement, e.g., load and display attached movie file
5. Determine if survey should be presented
6. Present Survey
7. Determine if secondary or different advertisement is to be displayed
8. Display Advertisement
9. Collect usage information, e.g., impressions for billing purposes
10. Update Database(s)

Word Definition/Synonym/Antonym/Figure/Document Lookup Tool
1. Load Database(s)
2. Receive request from drafting or third party display tool for word, definition, synonym, antonym, figure and/or document display (any one or any combination or all of the forgoing)
3. Determine Relevancy Information
4. Retrieve requested information, using relevancy information if applicable/available
5. Determine if additional browser page or popup or other display method is to be used (e.g., interstitial popup window)
6. Determine if application and/or end user has requested filter and/or sort and/or relevancy options
7. Display Requested Information (using filter, sort and/or relevancy information and/or filter criteria if applicable//available)
8. Update Database(s)

Document Submission/Filing Application
1. Load Database(s)
2. Receive request to submit patent or other document with words, synonyms, antonyms, figures and/or related documents to database, repository or processing agency, e.g., USPTO
3. Capture data and/or image of all relevant materials, including then current definitions, along with Time/Date stamp information
4. If desired, encrypt any or all output materials, e.g., patent application, definitions, words, synonyms, antonyms, figures and/or related documents and/or supporting materials to prevent or otherwise control subsequent access and/or modifications
5. Update Database(s)

Mapping Program
1. Load Databases
2. Receive indication that one or more patent applications, words, synonyms, antonyms and/or other documents or notes have been added or changed or removed from one or more databases
3. Receive or Determine Relevancy Information
4. Determine mapping relationships among the forgoing
5. Monitor patent application, word, synonym, antonym, and/or other documents and/or notes and/or mapping usage
6. Receive feedback from end users and/or determine change in mapping relationships and/or relevancy
7. If desired or required, submit any such changes for review/approval
8. If approved, update mapping relationship data accordingly
9. Update Databases

End User Contest Application
1. Load Database(s)
2. Receive Indication that one or more end users and/or third parties, e.g., patent examiner, contests one or more word definitions, words, synonyms, antonyms, figures and/or other documents and/or supporting materials and/or mappings
3. Determine relevancy/validity of the contest by any one or all of the following if desired/applicable
   a. Solicit other end user/third party votes/scores/ranking
   b. Use GA
   c. Submission to authorized end user or third party
   d. Preponderance of feedback
4. If contest is determined valid, accept requested changes
5. Otherwise Reject Requested Changes
6. Update Database(s)

Billing Program
1. Load Database(s)
2. Receive indication that billing activity has occurred
3. Determine affected parties, e.g., payer and payee
4. Determine billing rules, terms and conditions
5. Determine Billing Amounts Due
6. Create Invoice and A/P or A/R notices/entries
7. Send Invoices and notices
8. Update Databases
9. Await Payment
10. Receive Payment Indication
11. Apply Payments
12. Notify A/P or A/R systems/and/or affected parties
13. Determine if payments are timely/sufficient
14. If not, execute collections program
15. Update Database(s)

Collections Program
1. Receive indication payments are late and/or insufficient
2. Load Database(s)
3. If applicable, execute one or more of the following steps:
   a. Send late notice
   b. Send insufficient payment or funds notice
   c. Limit or prevent further use until payment terms are partially or fully satisfied, each according to billing terms and conditions and/or rules
   d. Collect funds due from primary and/or secondary credit cards on file.
   e. Notify affected parties
4. Update Database(s)

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
receiving a search request from an end user
retrieving one or more synonyms of a terms in the search request;
displaying the one or more synonyms to the end user;
receiving a request from the end user identifying one or more of the displayed synonyms to be included in the search request; and
including the identified one or more synonyms in the search request;
searching a document database for items that match the search request;
retrieving items that match the search request and identifying the items as the search results;
determining the relevancy of items in the search results;
weighting the items in the search results according to one or more predetermined factors; and
displaying the search results based on the determined relevancy and weight.

2. The method of claim 1 further comprising displaying the determined relevancy to the end user.

3. The method of claim 1 wherein at least one of the predetermined factors is provided by the user.

4. The method of claim 1 wherein at least one of the predetermined factors is based on the section of the document in which the search request appears in the search result item.

5. The method of claim 1 wherein the document database includes notes that are associated with documents after the documents are entered into the database.

6. The method of claim 4 wherein the section of the document is a note.

7. The method of claim 1 wherein the document database includes an advertisement that is associated with a document via one or more hyperlinked keywords in the document.

8. The method of claim 7 wherein the document section is an advertisement associated with the document.

9. The method of claim 1 further comprising presenting the end user with a survey question, wherein the answer to the survey question will be used to further define the search request.

10. The method of claim 7 further comprising:
receiving a response to the survey question from the end user; and
further defining the search request based on the answer to the survey question.

11. A method comprising:
receiving a search request from an end user
presenting the end user with a survey question, wherein the answer to the survey question will be used to further define the search request;
receiving a response to the survey question from the end user;
further defining the search request based on the answer to the survey question;
searching a document database for items that match the search request;
retrieving items that match the search request and identifying the items as the search results;
determining the relevancy of items in the search results;
weighting the items in the search results according to one or more predetermined factors; and
displaying the search results based on the determined relevancy and weight.

12. The method of claim 11 further comprising displaying the determined relevancy to the end user.

13. The method of claim 11 wherein at least one of the predetermined factors is provided by the user.

14. The method of claim 11 wherein at least one of the predetermined factors is based on the section of the document in which the search request appears in the search result item.

15. The method of claim 11 wherein the document database includes notes that are associated with documents after the documents are entered into the database.

16. The method of claim 14 wherein the section of the document is a note.

17. The method of claim 11 wherein the document database includes an advertisement that is associated with a document via one or more hyperlinked keywords in the document.

18. The method of claim 17 wherein the document section is an advertisement associated with the document.

19. The method of claim 11 further comprising:
retrieving one or more synonyms of a terms in the search request; and
displaying the one or more synonyms to the end user.

20. The method of claim 19 further comprising:
receiving a request from the end user identifying one or more of the displayed synonyms to be included in the search request; and
including the identified one or more synonyms in the search request.
